(19) United States
(12) Patent Application Publication
(10) Pub. No.: US 2026/0311920 A1
(43) Pub. Date: Oct. 8, 2026

(54) MAGNET RETENTION SYSTEM

(71) Applicant: NAIROBI INCORPORATED, Scottsdale, AZ (US)

(72) Inventor: Justin Eugene Evans, New Taipei City (TW)

(21) Appl. No.: 19/171,270

(22) Filed: Apr. 6, 2025

(51) Int. Cl. H01F 7/02

(52) U.S. Cl. CPC H01F 7/0221

(57) ABSTRACT

A magnet retention system includes magnets positioned in a housing having constraint surfaces or rails. The magnets have orthogonal magnetic polar axes, and their physical and magnetic properties are selected such that a magnetic interaction between the magnets generates forces that urge each magnet against constraint surfaces. The resulting normal forces produce static friction that retains the magnets in place without adhesives or mechanical fasteners. The system can be used to achieve robust, passive, and reversible magnet retention.

### FIELD

Embodiments of the invention generally relate to systems and methods for retention of magnets within an assembly. More specifically, embodiments of the invention concern systems and methods for passively securing magnets using magnetic interactions and static friction without the need for adhesives or mechanical fasteners.

### BACKGROUND

Magnetic components are commonly used in mechanical and electronic assemblies for positioning, alignment, and retention. In many known systems, magnets are fixed in place using adhesives, mechanical fasteners, or structures such as sleeves that clamp the magnet to a support. For example, some mounting systems use a sleeve that encloses both a magnet and a portion of a support structure, relying on compression or friction within the sleeve to retain the magnet. In other cases, magnets are held by interference fits or inserted into recesses in a non-magnetic carrier.

These known approaches often require additional parts, limit adjustability, or depend on precise tolerances. They may also hinder reversibility or complicate assembly, particularly in systems where low-profile or maintenance-free operation is desirable.

Moreover, while magnetic forces are sometimes used to retain components, known methods generally rely on magnet-to-surface attraction or simple magnet-to-magnet attraction along aligned poles.

Accordingly, there remains a need for improved retention systems that eliminate the need for adhesives or fasteners, use minimal components, provide stable, passive retention through simple assembly, and leverage magnetic interactions in novel orientations to generate static frictional holding forces.

### SUMMARY OF THE INVENTION

In one aspect, the invention concerns a method of retaining magnets. The method involves providing a housing having a cavity with at least two rails extending along at least a part of the length of the cavity; providing a first magnet and a second magnet, wherein the physical and magnetic properties of the first and second magnets are selected such that, when the first and second magnets are positioned in the cavity with their magnetic polar axes oriented orthogonally to one another, a magnetic interaction between the first and second magnets generates a transverse force that urges each of the first and second magnets against a respective one of the at least two rails, thereby retaining the magnets in place by static friction. This method can further include positioning the first magnet within the cavity in a first predetermined orientation along one of the rails. The method can additionally include positioning the second magnet within the cavity in a second predetermined orientation relative to the first magnet.

In one embodiment of the above method, the cavity is elongate. In some embodiments, each magnet comprises at least one planar surface that engages with a corresponding one of the rails to resist movement. In certain embodiments, at least one of the magnets is substantially cube shaped. In one embodiment, the rails are made of a diamagnetic material. In some embodiments, the method further involves inserting a stopper in the cavity. In certain embodiments, the stopper is made of a diamagnetic material.

In another aspect, the invention is directed to a method of retaining magnets without adhesives or mechanical fasteners. The method involves selecting a first magnet and a second magnet having physical and magnetic properties such that, when the magnets are positioned in a selected relative orientation and placed in proximity, a magnetic interaction between the magnets generates a force that urges each of the magnets against a corresponding physical constraint. The method can further include positioning the first magnet and the second magnet in the selected relative orientation and in contact with corresponding constraint surfaces such that the force generated by the magnetic interaction causes the magnets to be retained in position by static friction.

In one embodiment of the method, the magnets are bar magnets. In some embodiments, each bar magnet defines a magnetic polar axis, and the magnets are positioned such that their magnetic polar axes are oriented orthogonally relative to one another. In certain embodiments, the constraint surfaces are part of a housing. In one embodiment, the force generated by the magnetic interaction is a transverse force relative to a longitudinal axis of at least one of the magnets. In some embodiments, the magnets are retained in place in response to the static friction generated by contact with interior surfaces.

Yet another aspect of the invention relates to an apparatus for retaining magnets without adhesives or mechanical fasteners, the apparatus can include first and second magnets, each having physical and magnetic properties; one or more physical constraint surfaces positioned to contact the first and second magnets when the magnets are placed in proximity and in a relative orientation; preferably, the physical and magnetic properties of the magnets, and their relative orientation, are such that a magnetic interaction between the magnets generates a force that urges the magnets against one or more physical constraint surfaces; the magnets are thus retained in position by static friction between each of the magnets and the constraint surfaces. In one embodiment, the magnets are bar magnets.

In some embodiments, each magnet defines a magnetic polar axis, and the magnets are oriented such that their magnetic polar axes are orthogonal to one another. In certain embodiments, the physical constraint surfaces are part of, or coupled to, a housing of a device. In one embodiment, the housing defines a cavity in which the magnets are placed. In some embodiments, the cavity includes at least two rails coupled to interior surfaces of the housing, each rail configured to constrain rotational movement of the magnets. In certain embodiments, the force generated by the magnetic interaction is a transverse force relative to a longitudinal axis of at least one of the magnets. In one embodiment, the static friction arises from contact between each of the magnets and surfaces of a cavity wall arranged to oppose the direction of the force generated by the magnetic interaction.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A more complete understanding of the embodiments, and the attendant advantages and features thereof, will be more readily understood by reference to the following detailed description when considered in conjunction with the accompanying drawings wherein:

FIG. 1 is a schematic, perspective view of a magnet retention system according to one embodiment of the invention.

FIG. 2 is a perspective, top view of a magnet retention system as used in conjunction with a housing of a device, in accordance with one embodiment of the invention.

FIG. 3 is a detail view of the top view of FIG. 2 illustrating a magnet being retained by rails of the housing device of FIG. 2, in accordance with one embodiment of the invention.

FIG. 4 is a partial, perspective view of the housing and magnet retention system of FIG. 2.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing exemplary embodiments in detail, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In certain embodiments, the invention relates to systems and methods for retaining magnets without adhesives or mechanical fasteners. More specifically, in one embodiment, a system leverages magnetic interaction between two magnets, arranged in a particular relative orientation, to generate a force that urges each magnet against a corresponding constraint surface. The magnets are then retained in place by static friction, providing a robust, passive retention mechanism.

In one embodiment, an apparatus for retaining magnets includes a first magnet and a second magnet, each having defined physical and magnetic properties. These properties may include shape, size, magnetic strength, and pole orientation. The apparatus also includes one or more constraint surfaces arranged to physically engage the first and second magnets when the magnets are placed in proximity and in a selected relative orientation.

The physical and magnetic properties of the magnets, as well as their relative orientation, are selected such that a magnetic interaction occurs that produces a force component—preferably transverse to the magnetic polar axis of at least one magnet—that urges each magnet against an adjacent constraint surface. This force generates a normal load at the interface between each magnet and the constraint surface. As a result of this normal load, each magnet is held in place by static friction at its respective interface.

In some embodiments, the constraint surfaces are part of a housing that defines a cavity. The magnets may be positioned within the cavity such that each magnet is adjacent to an interior surface of the housing, or to structural elements (e.g., rails) affixed to the cavity walls. When properly oriented, the interaction between the magnets creates a lateral or transverse magnetic force that presses each magnet into firm contact with its corresponding surface. Retention is achieved through static friction generated by this contact, without the need for adhesives, fasteners, or other mechanical locking mechanisms.

A corresponding method includes selecting a first magnet and a second magnet having physical and magnetic properties suitable to produce a magnetic interaction that generates a lateral force when the magnets are oriented relative to one another. The method further includes positioning the magnets in the selected orientation and in contact with corresponding constraint surfaces, such that the force arising from their interaction urges each magnet into engagement with a surface. The magnets are then retained in place by static friction alone.

For example, in one embodiment, the first and second magnets are selected to be neodymium magnets having different shapes: the first magnet is an elongated rectangular prism (i.e., a bar magnet), and the second magnet is substantially cubic. Each magnet defines a magnetic polar axis, with the axis of the bar magnet extending along its longest dimension and the cube magnet having a shorter, more symmetric field distribution. The magnets are positioned in a cavity such that their magnetic polar axes are oriented orthogonally to one another—e.g., with the bar magnet’s axis oriented horizontally and the cube magnet’s axis oriented vertically. This orthogonal configuration produces a magnetic interaction with a transverse component that urges each magnet outward, against adjacent constraint surfaces. By appropriately selecting the magnets’ shapes, sizes, and field strengths (e.g., N52-grade neodymium), the interaction can be tuned to produce a normal force sufficient to generate static friction for reliable retention. The selection of magnet properties may be based on simulation, modeling, or empirical testing to determine the resulting field geometry and force vectors as a function of magnet grade, size, and their positioning within the cavity. Alternatively, the magnets may be placed in a test housing or non-magnetic fixture, and the resulting lateral force or displacement resistance can be measured to ensure that the generated normal force is sufficient to produce the desired static friction for retention. Preferably, one of the magnets is four times longer than the other magnet; however, a ratio of 2:1, 3:1, 5:1 or 6:1 (or any ratio in between) in length is suitable also. These techniques are within the skill of a person of ordinary skill in the art and do not require undue experimentation. For example, the interaction may generate a lateral force of at least 2N per contact surface, providing robust retention when the magnets are in contact with housing walls having a coefficient of friction around 0.3. This allows the magnets to remain securely in place under vibration, shock, or normal use conditions without adhesives or mechanical fasteners.

In some embodiments, the magnets may be bar magnets or cuboid-shaped magnets with planar surfaces. The magnetic polar axes of the magnets may be oriented orthogonally to one another, such that the resulting magnetic interaction includes a transverse component. Constraint surfaces may be diamagnetic or non-magnetic, and may optionally include friction-enhancing coatings or material layers.

The system is especially useful in applications requiring secure yet reversible retention, including robotics, precision instruments, and other assemblies that benefit from vibration-resistant, low-maintenance magnetic positioning without the use of consumable materials or added mechanical complexity.

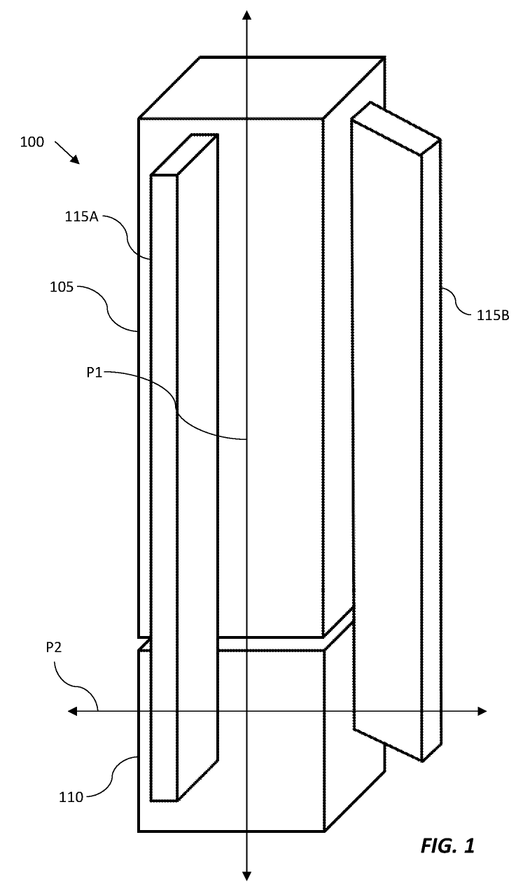

FIG. 1 illustrates an embodiment of magnet retention system 100, configured to retain magnet 105 and magnet 110 without adhesives or mechanical fasteners. Magnet retention system 100 includes physical constraint structures 115A, 115B. In one embodiment, constraint structures can be suitably configured as rails of a device.

In one embodiment, magnet 105 can be an elongate prism, and magnet 110 can be a substantially cuboid magnet having a height that is less than the height of magnet 105. In the illustrated embodiment, magnet 105 defines a magnetic polar axis P1, and magnet 110 defines a magnetic polar axis P2, where magnetic polar axis P1 and magnetic polar axis P2 are orthogonal to one another. Magnets 105, 110 are placed adjacent to one another such that magnets 105, 110 contact constraint structures 115A, 115B along adjacent exterior faces of each magnet 105, 110.

The physical and magnetic properties of magnets 105, 110, including their geometry, size, and relative polarity orientation, are selected such that a magnetic interaction occurs between magnets 105, 110. The magnetic interaction produces a torque and a lateral force component that urge magnets 105, 110 into contact with constraint structures 115A, 115B.

The magnetic interaction between magnet 105 and magnet 110, resulting from their orthogonal magnetic polarities (P1 and P2, respectively), generates a set of opposing forces and torques that tend to rotate and displace magnet 105 and magnet 110 relative to one another. However, because magnet 105 and magnet 110 are each placed in contact with constraint structures 115A, 115B, constraint structures 115A, 115B resist this motion and provide reaction forces oriented normal to the contact faces of magnet 105 and magnet 110. These reaction forces produce normal loads between magnet 105 and constraint structures 115A, 115B, and between magnet 110 and constraint structures 115A, 115B, which in turn generate static friction at each interface. The resulting frictional forces oppose both translational and rotational movement of magnets 105, 110, allowing them to remain passively secured. The magnitude of the frictional forces can be tuned by selecting the magnetic strength, geometry, and material properties of magnets 105, 110 and constraint structures 115A, 115B to ensure reliable retention under expected vibrational or impact loading conditions.

This configuration enables passive, reversible magnetic retention in which magnets 105, 110 remain secured in place without the use of adhesives, mechanical fasteners, or other attachment mechanisms. The interaction between magnets 105, 110, in combination with constraint structures 115A, 115B, provides a robust and mechanically stable arrangement well suited for applications requiring vibration resistance and long-term positioning without maintenance or consumable materials.

Although magnets 105, 110 are shown and described with specific geometries—namely, an elongated prism and a cuboid—this configuration is merely illustrative. In other embodiments, magnet 105 and magnet 110 may have other geometries, including cylindrical, trapezoidal, non-prismatic, or irregular shapes, provided that magnets 105, 110 define respective magnetic polar axes suitable for establishing the desired orthogonal magnetic interaction and surface retention through static friction.

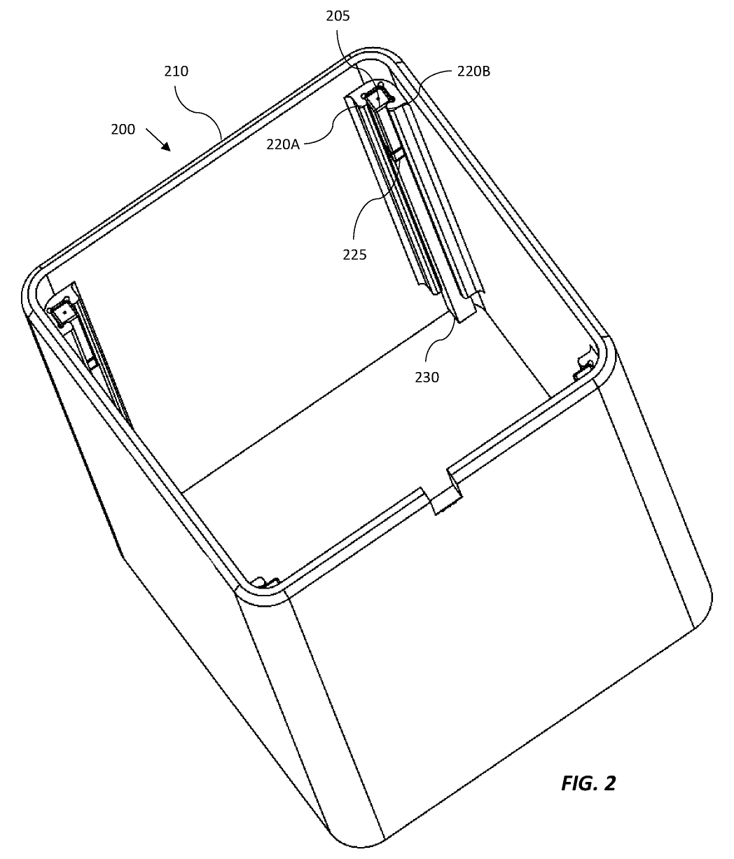

FIGS. 2 through 4 illustrate an embodiment of a magnet retention system integrated into device 200 having housing 210. Device 200 can be, for example, a radiation emitting device such as those described in copending application 19/070,747, titled “Magnetic Retention System”, with a filing date of Mar. 5, 2025, which application is hereby incorporated herein by reference in its entirety. In one embodiment, device 200 can include housing 210 defining an interior cavity and a corner into which rails 220A, 220B are integrated. Housing 210 can be part of a complete housing assembly having a top and a bottom (not shown). In the embodiment illustrated, rails 220A, 220B are integrally formed as part of housing 210, such as by a plastic extrusion process. However, in other embodiments, rails 220A, 220B can be separate components mechanically or adhesively coupled to housing 210, such as by fasteners, bonding, or friction fit. Rails 220A, 220B are embodiments of constraint structures 115A, 115B of FIG. 1.

As best shown in FIG. 2, magnets 205, 225 are placed adjacent to each other in contact with rails 220A, 220B. Magnets 205, 225 can be, respectively, a bar magnet and a cube magnet, although in other embodiments other shapes and dimensions can be used.

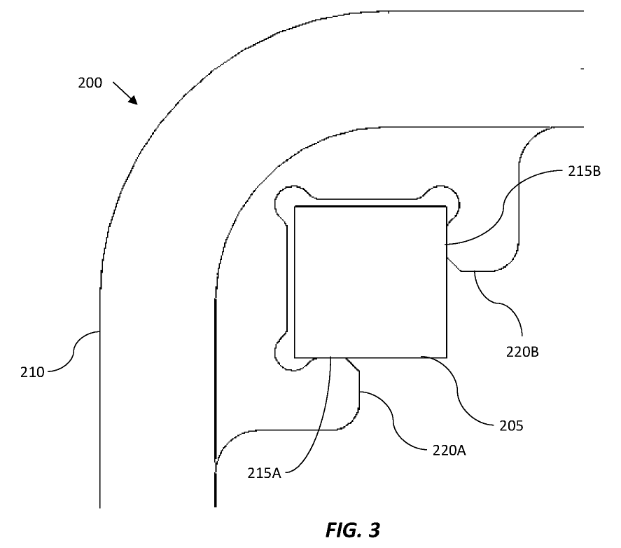

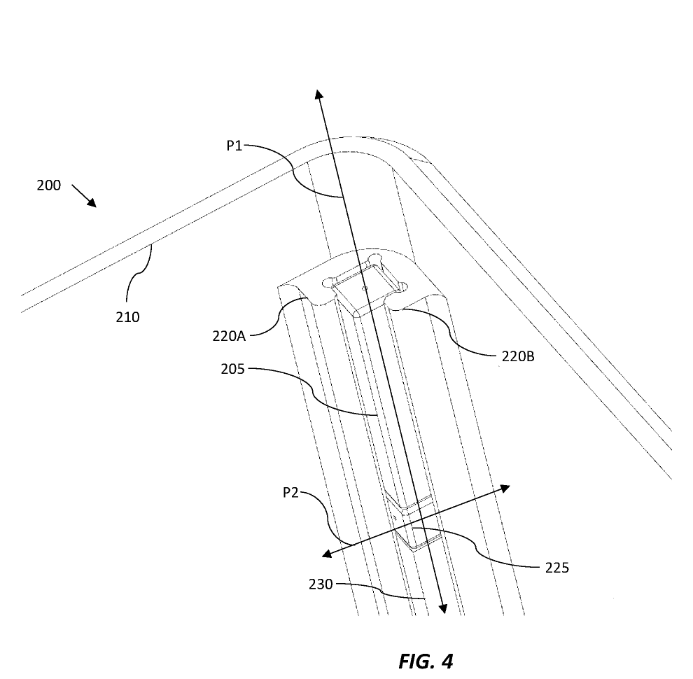

Rails 220A, 220B define two orthogonal wall surfaces 215A, 215B (see FIG. 3), which are configured to constrain magnets 205, 225 from rotating. In this embodiment, magnets 205, 225 are urged against wall surfaces 215A, 215B due to the interaction between magnets 205, 225 and their orthogonal polarities P1, P2 (See FIG. 4). FIG. 3 shows magnet 205 in contact with constraint wall surfaces 215A, 215B, though it should be understood that the contact areas may differ depending on tolerance and placement.

Wall surfaces 215A, 215B are formed respectively as part of rails 220A, 220B. In this embodiment, a slight clearance gap is present between magnets 205, 225 and the sidewalls of housing 210 (See FIG. 3), facilitating ease of insertion during assembly. However, in actual operation, magnets 205, 225 are urged against wall surfaces 215A, 215B by magnetic forces, thereby generating a normal force at wall surfaces 215A, 215B that gives rise to static friction sufficient to retain magnets 205, 225 in position.

As illustrated in FIG. 4, magnet 205 has magnetic polarity vector P1, and magnet 225 has magnetic polarity vector P2. Magnets 205, 225 are oriented such that their respective polarities P1, P2 are orthogonal to one another. This orthogonal configuration creates a magnetic interaction between magnets 205, 225 that results in a force—most notably a torque on each magnet 205, 225—that urges each magnet 205, 225 against rails 220A, 220B. In the embodiment shown, a spacer 230 can be used to help maintain a desired spacing and alignment, although it is not required for proper functioning of the system.

The frictional retention achieved in this embodiment requires no adhesive, mechanical fasteners, or detents. Instead, the system relies entirely on the magnetic interaction and the resulting static friction at the interfaces between magnets 205, 225 and the corresponding wall surfaces 215A, 215B. The geometry of the magnets (e.g., elongated bar for 205 and compact cube for 225) can be selected to enhance this effect by providing differing torque arms and field interactions, which help to direct force vectors orthogonally with respect to each of magnet 205, 225 polar axis, and to stabilize the assembly within the corner of housing 210.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible considering the above teachings without departing from the following claims.

1. A method of retaining magnets, the method comprising:
providing a housing having a cavity with at least two rails extending along at least a part of the length of the cavity;
providing a first magnet and a second magnet, wherein the physical and magnetic properties of the first and second magnets are selected such that, when the first and second magnets are positioned in the cavity with their magnetic polar axes oriented orthogonally to one another, a magnetic interaction between the first and second magnets generates a transverse force that urges each of the first and second magnets against the at least two rails, thereby retaining the magnets in place by static friction;
positioning the first magnet within the cavity in a first predetermined orientation along one of the at least two rails; and
positioning the second magnet within the cavity in a second predetermined orientation relative to the first magnet.

2. The method of claim 1, wherein the cavity is elongate.

3. The method of claim 1, wherein the first magnet and the second magnet each comprises at least one planar surface that engages with a corresponding one of the at least two rails to resist movement.

4. The method of claim 3, wherein at least one of the first and second magnets is substantially cube shaped.

5. The method of claim 1, wherein at least one of the at least two rails comprises a diamagnetic material.

6. The method of claim 1, further comprising inserting a stopper in the cavity.

7. A method of retaining magnets without adhesives or mechanical fasteners, the method comprising:
selecting a first magnet and a second magnet having physical and magnetic properties such that, when the magnets are positioned in a selected relative orientation and placed in proximity, a magnetic interaction between the first and second magnets generates a force that urges each of the first and second magnets against a physical constraint; and
positioning the first magnet and the second magnet in the selected relative orientation and in contact with surfaces of the physical constraints such that a force generated by the magnetic interaction causes each of the first and second magnets to be retained in position by static friction.

8. The method of claim 7, wherein the first magnet and the second magnet each comprises a bar magnet.

9. The method of claim 8, wherein each bar magnet defines a magnetic polar axis, and the first and second magnets are positioned such that their magnetic polar axes are oriented orthogonally relative to one another.

10. The method of claim 7, wherein the physical constraints are part of a housing.

11. The method of claim 7, wherein the force generated by the magnetic interaction is a transverse force relative to a longitudinal axis of at least one of the magnets.

12. The method of claim 11, wherein the first and second magnets are retained in place in response to the static friction generated by contact with orthogonal interior surfaces.

13. An apparatus configured for retaining magnets without adhesives or mechanical fasteners, the apparatus comprising:
a first magnet and a second magnet, each having physical and magnetic properties;
one or more physical constraint surfaces positioned to contact the first and second magnets when the first and second magnets are placed in proximity and in a relative orientation;
wherein the physical and magnetic properties of the first and second magnets, and their relative orientation, are such that a magnetic interaction between the first and second magnets generates a force that urges each of the first and second magnets against the one or more physical constraint surfaces; and
wherein the first and second magnets are retained in position by static friction between each of the first and second magnets and the one or more physical constraint surfaces.

14. The apparatus of claim 13, wherein the first magnet and the second magnet each comprises a bar magnet.

15. The apparatus of claim 14, wherein each bar magnet defines a magnetic polar axis, and the first and second magnets are oriented such that their magnetic polar axes are orthogonal to one another.

16. The apparatus of claim 13, wherein the physical constraint surfaces are part of a housing.

17. The apparatus of claim 16, wherein the housing defines a cavity in which the first and second magnets are positioned.

18. The apparatus of claim 17, wherein the cavity comprises at least two rails coupled to interior surfaces of the housing, each rail configured to receive and constrain one of the first and second magnets.

19. The apparatus of claim 13, wherein the force generated by the magnetic interaction is a transverse force relative to a longitudinal axis of at least one of the magnets.

20. The apparatus of claim 13, wherein the static friction arises from contact between each of the first and second magnets and a corresponding surface of a cavity wall arranged to oppose the direction of the normal force generated by the magnetic interaction.
